(19) United States
(12) Patent Application Publication
(10) Pub. No.: US 2025/0318692 A1
(43) Pub. Date: Oct. 16, 2025

(54) GRILLING UTILITY BOX SYSTEM

(71) Applicant: EADES HOLDING LLC, Buffalo, WY (US)

(72) Inventor: Patrick Eades, II, MARIETTA, GA (US)

(73) Assignee: EADES HOLDING LLC, Buffalo, WY (US)

(21) Appl. No.: 18/636,896

(22) Filed: Apr. 16, 2024

(51) Int. Cl. A47J 47/16; A47J 37/07; A47J 45/02; A47J 47/00

(52) U.S. Cl. CPC A47J 47/16; A47J 45/02; A47J 47/005; A47J 37/0786

(57) ABSTRACT

A utility box system is disclosed. The utility box system may include a hollow bin and a lid configured to cover the hollow bin. The hollow bin may include a base and a plurality of bin sidewalls attached to the base. The utility box system may further include a utility item holder that is pivotally attached to a bin sidewall of the plurality of bin sidewalls. The utility item holder may be configured to store one or more items in an upright position. The utility item holder may be configured to rotate and pivotally move between a first position and a second position such that the utility item holder maintains the upright position in the first and the second position. The first position may be located in proximity to a bin sidewall inner surface and the second position may be located in proximity to a bin sidewall outer surface.

### TECHNICAL FIELD

The present disclosure relates to a grilling utility box system, and more specifically to a grilling utility box system configured to organize and hold grilling accessories.

### BACKGROUND

A user may use a grill to cook food items such as vegetables and meat. While using the grill, the user may require a lot of items/accessories such tongs, knives, a cutting board, etc. to efficiently cook the food items. Sometimes, it may become difficult for the user to quickly locate and manage all the accessories during the cooking process, which may cause inconvenience to the user and may even result in suboptimal food preparation. Thus, there is a need for a device or a system that enables the user to conveniently organize and store such accessories when the user may be cooking food items on a grill.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a first example view of a grilling utility box system in accordance with the present disclosure.

FIG. 3 depicts a second example view of a grilling utility box system in accordance with the present disclosure.

FIG. 4A depicts example utility box holders of a grilling utility box system in a first position, in accordance with the present disclosure.

FIG. 4B depicts example utility box holders of a grilling utility box system in a second position, in accordance with the present disclosure.

FIG. 5A depicts an example garbage holder of a grilling utility box system in a closed position, in accordance with the present disclosure.

FIG. 5B depicts an example garbage holder of a grilling utility box system in an open position, in accordance with the present disclosure.

### DETAILED DESCRIPTION

### Overview

The present disclosure is directed towards a grilling utility box system that may be configured to store and organize items or accessories that may be required for grilling. For example, a user may use the grilling utility box system to store items such as knives, tongs, aluminum foil, paper towel, butcher paper, parchment paper, salt, pepper, cutting board, etc., which may be required to cook food on a grill.

The grilling utility box system may include a hollow bin and a lid that may cover the hollow bin. In some aspects, the lid may be hinged at a bin top edge. In other aspects, the lid may be removably attached to a bin top portion. The lid may be configured to move between an open position and a closed position to cover or uncover the hollow bin. The lid may include a lid top surface and a lid bottom surface.

The lid may include a cutting board that may be attached to the lid top surface. The cutting board may be screwed or removably attached to the lid top surface. In some aspects, the lid may further include magnets on the lid top surface to facilitate the user to conveniently place the knives on the lid top surface (e.g., after using the cutting board). In addition, the lid may include one or more brackets (at the lid bottom surface) to hold rolled goods such as aluminum foil, paper towel, butcher paper, parchment paper, etc. Further, the lid may include additional magnets at the lid bottom surface to store knives (e.g., when the knives may not be required to be used).

In some aspects, the grilling utility box system may further include utility holder(s) that may be pivotally attached to a bin sidewall. The utility item holders may include a beverage holder, a hook tray, a storage basket, and/or the like. The utility item holders may store items such as beverage, tong, salt, pepper, etc. In some aspects, the utility item holders may be pivotally attached to inner surfaces or top edges of bin sidewall(s), and may be configured to move/rotate between a first position and a second position. The first position may be in a bin interior portion and the second position may be in a bin exterior portion. Stated another way, the first position may be in proximity to a sidewall inner surface and the second position may be in proximity to a sidewall outer/exterior surface.

In further aspects, the grilling utility box may include a garbage holder that may be positioned at the sidewall outer surface, which may be used to store trash/garbage. In some aspects, the garbage holder may be a ring like structure to which a trash bag may be attached. The garbage holder may be configured to pivotally move between a closed position and an open position, when the lid moves between the open position and the closed position. When the garbage holder may be in open position, the user may store trash in the trash bag attached to the garbage holder.

The present disclosure discloses a grilling utility box that is a portable box, which enables the user to manage all the items/accessories required for grilling in one place, and conveniently perform operations such as cutting using the grilling utility box.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

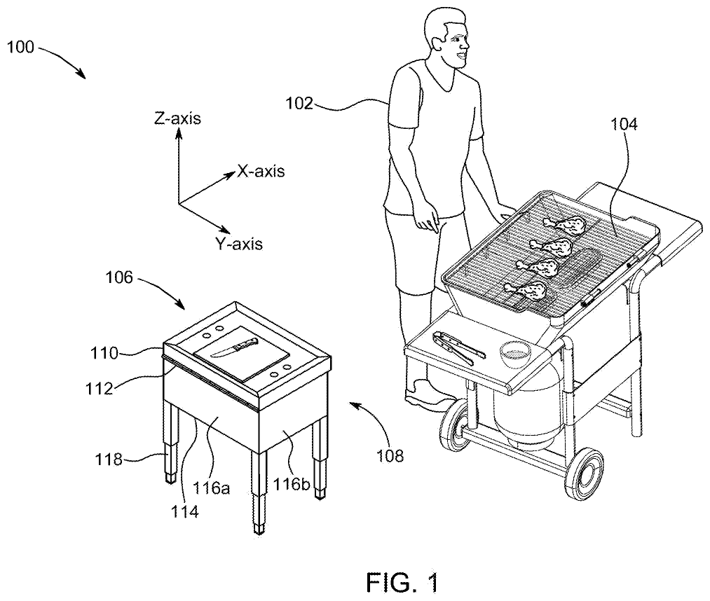

FIG. 1 depicts an example environment 100 in which techniques and structures for providing the systems and methods disclosed herein may be implemented. The environment 100 may include a user 102 grilling a food item (such as vegetable, meat etc.) on a grill 104. The environment 100 may further include a utility box system 106 or system 106 that may be configured to organize and store items (e.g., grilling accessories) that may be required by the user 102 to conveniently and efficiently cook the food items on the grill 104. The items/accessories may include, but are not limited to, knives, tongs, a roll of aluminum foil, paper towel, butcher paper, parchment paper, salt, pepper, a cutting board, and/or the like. The user 102 may place the system 106 in proximity to the grill 104 to allow the user 102 to conveniently use and manage the items at one place while cooking food on the grill 104.

The system 106 may include a hollow bin 108 (hereinafter referred to as bin 108), and a lid 110 configured to cover the bin 108. In some aspects, the lid 110 may be hinged (or pivotally attached via a hinge 112) at a top edge/portion of the bin 108, thereby enabling the lid 110 to rotate about the bin's top edge. The user 102 may rotate the lid 110 to move the lid 110 between a closed position (at which the lid 110 completely covers the bin's top portion) and an open position (at which the lid 110 uncovers the bin's top portion, thereby enabling the user 102 to access the bin's hollow interior portion).

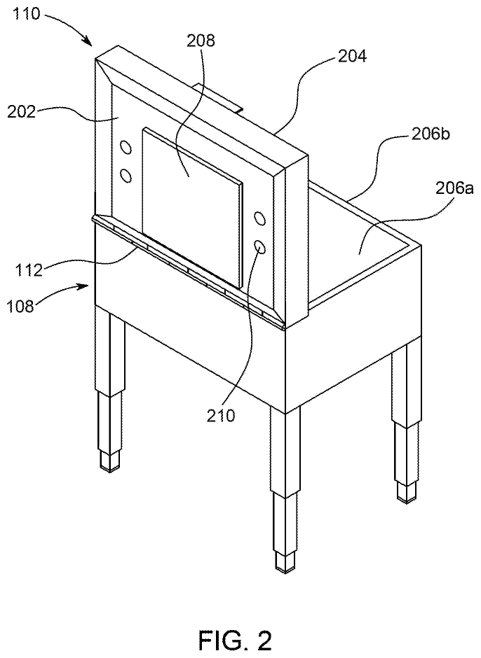

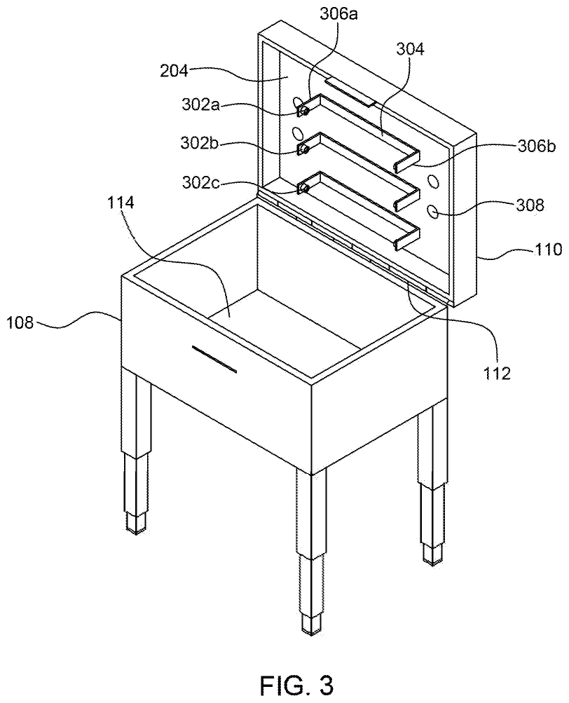

In other aspects, the lid 110 may be removably attached to the bin 108 (e.g., to a bin top portion). In this case as well, the lid 110 may be configured to move between the open position and the closed position. The user 102 may remove the lid 110 from the bin's top portion to move the lid 110 to the open position, and cover or place the lid 110 at the bin's top portion to move the lid 110 to the closed position. In the closed position, the lid 110 may completely cover the bin 108 (specifically, the bin's top portion), as shown in FIG. 1. In the open position, the lid 110 may partially or completely uncover the bin 108 (e.g., from the bin's top portion), as shown in FIGS. 2 and 3.

In some aspects, the user 102 may keep the lid 110 in the closed position when the system 106 may not be in use. The user 102 may move the lid 110 to the open position to access the items stored in the system 106 or when the user 102 may be using the grill 104 to cook food. In some aspects, the lid 110 may include a lid top surface 202 and a lid bottom surface 204 (as shown in FIGS. 2 and 3). The lid bottom surface 204 may face the bin's interior portion when the lid 110 is in the closed position, and the lid top surface 202 may be disposed opposite to the bin's interior portion when the lid 110 is in the closed portion. The lid 110 may include a gasket or a seal (not shown) at the lid bottom surface 204 to securely attach the lid 110 to the bin top portion. The use of the gasket or seal may provide waterproof connection between the bin 108 and the lid 110, when the lid 110 may be moved or secured in the closed position.

In some aspects, one or more system units/elements (e.g., the bin 108, the lid 110, and/or the like) may be made of plastic. In further aspects, the system units may be made of any other material such as steel or any other metal. In some aspects, the bin 108 and the lid 110 may be made of same material. Alternatively, the bin 108 and the lid 110 may be made of different materials. In further aspects, the bin 108 and the lid 110 may be made of waterproof material, so that water may not seep into the bin's interior portion when the lid 110 is in the closed position. In some aspects, the system 106 may be shaped as a cube or a cuboid, as shown in FIG. 1. In this case, the bin 108 may be shaped as a cube or a cuboid, and the lid 110 may be shaped as a square or rectangular plate. In alternative aspects, the system 106 may have any other shape, without departing from the present disclosure scope. The system 106 may be of any dimension. For example, the system 106 may have a height, length and breadth in a range of 20 cm-40 cm.

The bin 108 may include a base 114 and a plurality of sidewalls 116a, 116b (collectively referred as sidewalls 116) attached to the base 114. In an exemplary aspect, when the system 106 is shaped as a cube or cuboid, a sidewall plane of each sidewall 116 may be perpendicular to a base plane. For example, as shown in FIG. 1, when the base plane is aligned with the X-Y plane, the sidewall plane may be aligned with the X-Z plane or the Y-Z plane. In some aspects, the base 114 and the sidewalls 116 may collectively form a bin interior portion that may be hollow and configured to store one or more items described above. Each sidewall 116 may include a sidewall inner surface 206a, and a sidewall outer surface 206b opposite to the sidewall inner surface (as shown in FIG. 2). The sidewall inner surface 206a may face towards the hollow bin interior portion, and the sidewall outer surface 206b may be disposed opposite to the hollow bin interior portion.

In further aspects, the system 106 may include one or more telescopic legs 118 that may facilitate the user 102 to adjust a system height according to user's requirements. In some aspects, the telescopic legs 118 may be connected to the base 114 (e.g., a base outer surface that may face the ground). Further, in some aspects, the telescopic legs 118 may be made of the same material as the bin 108. Alternatively, the telescopic legs 118 may be made of a different material than the material used to make the bin 108.

The system 106 may include a plurality of additional elements and features that may enhance user's convenience of using the system 106 and storing the grilling accessories, when the user 102 cooks food using the grill 104. The details of such additional elements and features are described below in conjunction with subsequent figures.

FIG. 2 depicts a first example view of the system 106 in accordance with the present disclosure. Specifically, FIG. 2 depicts a back isometric view of the system 106 with the lid 110 in the open position. As described above, the lid 110 may include the lid top surface 202 and the lid bottom surface 204 (opposite to the lid top surface 202). In some aspects, the lid bottom surface 204 may face towards the base 114 (or the bin interior portion), and the lid top surface 202 may face away from the base 114 (or the bin interior portion), when the lid 110 may be in a closed position.

In one exemplary aspect, the lid 110 may include a cutting board 208 that may be attached to the lid top surface 202. The cutting board 208 may be used for cutting food items (e.g., meat, vegetables, etc.), when the user 102 may be cooking food using the grill 104 with the system 106 placed in proximity to the grill 104. The cutting board 208 may be a conventional cutting board, made of known cutting board material. In some aspects, the cutting board 208 may be attached to the lid top surface 202 by using one or more fasteners such as screws and/or an adhesive. In other aspects, the cutting board 208 may be removably attached to the lid top surface 202 by using a fastener. For example, the cutting board 208 may be removably attached to the lid top surface 202 by using retaining clips that may be made of plastic, or any other similar fastener. The user 102 may attach the cutting board 208 on the lid 110 when the user 102 may need to use the cutting board 208 (e.g., to cut food items). The lid 110 may provide support and stability to the cutting board 208, and may enable the user 102 to conveniently cut the food. The user 102 may use the cutting board 208 when the lid 110 is in the closed position, or the user 102 may use the cutting board 208 by detaching the lid 110 off the bin 108 and then placing the lid 110 on a flat surface to use the cutting board 208. The user 102 may detach the cutting board 208 from the lid 110 when the user 102 requires to clean the cutting board 208.

The cutting board 208 may be of any shape and dimensions. In some aspects, the shape and dimensions of the cutting board 208 may correspond to the shape and dimensions of the lid 110. For example, a cutting board length may be 30-90% of a lid length, and a cutting board width may be 40-90% of a lid width. In some aspects, the cutting board 208 may be placed at any location on the lid top surface 202. For example, the cutting board 208 may be disposed at a center portion of the lid top surface 202. Alternatively, the cutting board 208 may be disposed at a side portion of the lid top surface 202 (or in proximity of a lid edge).

In further aspects, the lid 110 may include one or more first magnet(s) 210 that may be disposed at the lid top surface 202. The first magnet(s) 210 may be disposed adjacent or in proximity to the cutting board 208. The first magnet(s) 210 may be configured to magnetically attach to ferrous utility items, such as knives, tongs, etc. The first magnet(s) 210 may enable the user 102 to conveniently place the ferrous utility items on the lid top surface 202 after cutting food on the cutting board 208, thereby significantly enhancing user's convenience of quickly and efficiently managing and storing grilling accessories during and after usage. The magnetic coupling between the first magnet(s) 210 and the ferrous utility items may prevent the items from falling off the lid top surface 202. The first magnet(s) 210 may be of any shape and size. For example, the first magnet(s) 210 may be circular in shape. In some aspects, the first magnet(s) 210 may be a magnetic bar that may be configured to hold a plurality of ferrous utility items simultaneously.

FIG. 3 depicts a second example view of the system 106 in accordance with the present disclosure. Specifically, FIG. 3 depicts a front view of the system 106 with the lid 110 in the open position. In some aspects, the lid 110 may include one or more holders at the lid bottom surface 204 to hold the items or grilling accessories. In an exemplary aspect, the lid 110 may include three brackets 302a, 302b, 302c (collectively referred to brackets 302) that may be configured to hold rolled goods. The rolled goods may include, but are not limited to, a roll of aluminum foil, paper towel, butcher paper, parchment paper, and/or the like. The bracket 302 may be a rolled good dispenser such as a foil dispenser. In some aspects, the brackets 302 may be attached to the lid bottom surface 204 by using a fastener such as a screw or an adhesive. In further aspects, the bracket 302 may be removably attached to the lid bottom surface 204 by using a fastener such as retaining clips. In further aspects, the lid 110 may include more or less than three brackets.

Each bracket 302 may be made of a horizontal rod 304 and two vertical rods 306a, 306b. The horizontal rod 304 may be connected between the two vertical rods 306a, 306b. Stated another way, the vertical rods 306a, 306b may be connected at opposite edges of the horizontal rod 304. The horizontal rod 304 and the vertical rods 306a, 306b may form a unified bracket piece. The vertical rods 306a, 306b may be configured to support/hold the opposite edges of the rolled goods, which may facilitate the user to unroll a portion of rolled goods and use it while cooking the food on the grill 104.

In some aspects, the brackets 302 may be made of any material such as plastic, wood, steel etc. The brackets 302 may be of any dimensions. In some aspects, the material and dimensions of all the brackets 302 may be same. In other aspects, the material and dimensions of all the brackets 302 may be different. In some aspects, the dimensions of the brackets 302 may correspond to the dimensions of the lid 110. For example, a bracket length may be 20-70% of a lid length, and a bracket width may be 5-30% of a lid width. In some aspects, the brackets 302 may be placed at any location on the lid bottom surface 204. For example, the brackets 302 may be disposed at a center portion of the lid bottom surface 204. Alternatively, the brackets 302 may be disposed at a side portion of the lid bottom surface 204 (or in proximity to a lid edge).

In some aspects, the brackets 302 may be reconfigurable or repositionable. Stated another way, the brackets 302 may be movable and may be moved from a first position to a second position on the lid bottom surface 204. This enables the user 102 to position the brackets 302 on the lid bottom surface 204 based on a rolled good type or user's preferences. For example, the user 102 may move the brackets 302a and 302c towards opposite edges of the lid 110 to create more space for the bracket 302b (e.g., to keep more space for a bracket for paper towel relative to a bracket for aluminum foil).

In further aspects, the lid 110 may include one or more second magnet(s) 308 that may be disposed on the lid bottom surface 204. The second magnet(s) 308 may be configured to magnetically attach with one or more ferrous utility items such as knives, tongs, etc., which may enable the user 102 to conveniently store such items in the underside of the lid 110 (e.g., the lid bottom surface 204) and protect them from ambient environment (e.g., when the items may not be in use and the lid 110 may be in the closed position). In further aspects, the lid 110 may include a sleeve (not shown) to hold the knives inside the system 106. The sleeve may be located on the lid bottom surface 204, which enables the user 102 to slide the knives in the sleeve when the knives may not be required.

In some aspects, the second magnet(s) 308 may be same as the first magnet(s) 210. For example, the shape/dimension of the second magnet(s) 308 may be same as the first magnet(s) 210. In other aspects, the second magnet(s) 308 may be different from the first magnet(s) 210.

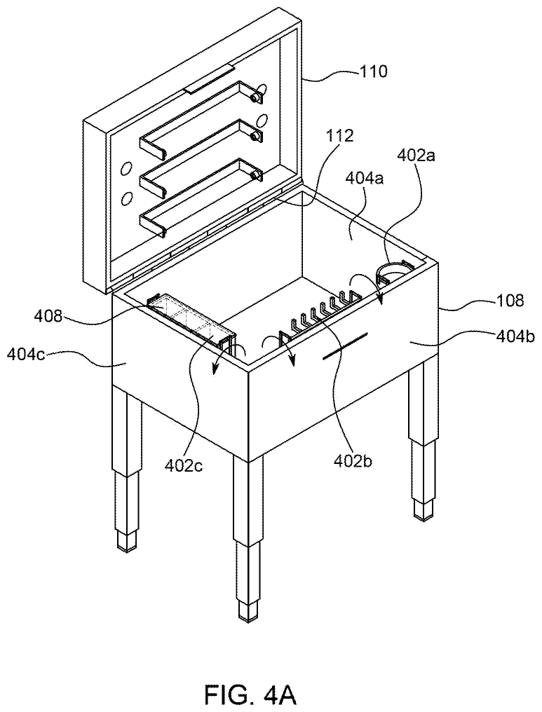

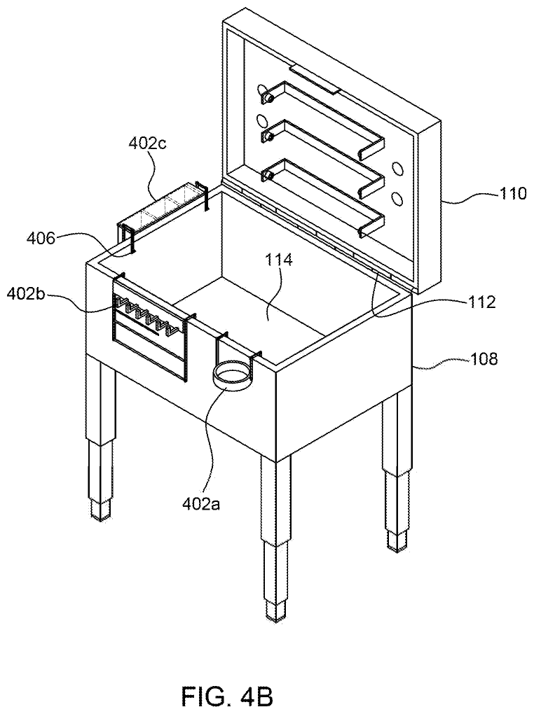

FIGS. 4A and 4B depict example utility box holders 402a, 402b, 402c (collectively referred to as utility item holders 402) of the system 106 in a first position and a second position, in accordance with the present disclosure. The utility item holders 402 may include, but is not limited to, a beverage holder 402a, a hook tray 402b, a storage basket 402c, and/or the like. The beverage holder 402a may be configured to hold a cup or a glass. The hook tray 402b may be configured to hold utensils (such as tongs, spatula, etc.) and other items. The storage basket 402c may be configured to hold items such containers for salt, pepper, sauces, and/or the like.

In some aspects, the utility item holders 402 may be pivotally attached to one or more sidewalls 404a, 404b, 404c (collectively referred as sidewalls 404, the sidewalls 404 is same as the sidewalls 116 described in FIG. 1) via one or more hinges 406 (as shown in FIG. 4B) so that the utility item holders 402 may be rotated via the respective hinged connection. In some aspects, the utility item holders 402 may be pivotally attached to an inner surface or a top edge of the respective sidewalls 404. As described above, the sidewall inner surface may face towards the bin interior portion. As an example, the beverage holder 402a may be pivotally attached to the inner surface or the top edge of the sidewall 404a, the hook tray 402b may be pivotally attached to the inner surface or the top edge of the sidewall 404b, and the storage basket 402c may be pivotally attached to the inner surface or the top edge of the sidewall 404c.

In some aspects, each utility item holder 402 may be configured to store items in an upright position. For example, the beverage holder 402a may hold a beverage glass in the upright position, the storage basket 402c may store a salt container in the upright position, and/or the like. In some aspects, an item's upright position mean that the item's longitudinal axis is perpendicular to the ground surface. In some aspects, the utility item holders 402 may be configured to rotate and pivotally move between a first position and a second position such that the utility item holders 402 maintain their upright positions (and the upright positions of the items stored in the respective holders, thereby not causing any spillage) in the first position and the second position. The utility item holders 402 may remain attached (e.g., pivotally attached) to the respective sidewalls 404 when the utility item holders 402 may be moved between the first position and the second position.

In some aspects, the first position may be located in proximity to a bin sidewall inner surface, and the second position may be located in proximity to a bin sidewall outer surface. Stated another way, the first position may be located in a bin interior portion and the second position may be located in a bin exterior portion. Thus, in the first position, the utility item holders 402 may be inside the bin 108, as shown in FIG. 4A, and in the second position, the utility item holders 402 may be outside the bin 108, as shown in FIG. 4B.

In some aspects, one or more utility item holders 402 may include a securing mechanism that may enable the items to stay secured (and not move laterally) when the utility item holder 402 may be moved between the first position and the second position. For example, the storage basket 402c may include a netted pocket with a closable top portion 408 (i.e., the top portion may be configured to lock or unlock). In some aspects, the top portion 408 may be locked/unlocked by using a fastener. The fastener may include, but is not limited to, a zipper, Velcro, snap buttons, and/or the like. The user 102 may keep the top portion 408 in the locked position when the items in the storage basket 402c may not be required to be used (to keep the items in the upright position and secured in the storage basket 402c), and may open/unlock the top portion 408 when the user 102 desires to access the items in the storage basket 402c. In further aspects, the storage basket 402c may include a foam or rubber like material in the bottom portion that may be configured to hold the items in the upright position in both the first position and the second position.

In some aspects, when the user 102 opens the lid 110 (e.g., moves the lid 110 to the open position), the user 102 may manually rotate the utility item holders 402 to move them from the first position (or the bin interior portion) to the second position (or the bin exterior portion). When the user 102 desires to close the lid 110 (or desires to move the lid 110 to the closed position), the user 102 may move the utility item holders 402 from the second position to the first position. When the utility item holders 402 are in the second position, the user 102 may place the items in the utility item holders 402 (e.g., in the hook tray 402b) to easily access and manage them while cooking food on the grill 104. For example, the user 102 may place a tong in the hook tray to quickly access it. In addition, the user 102 may place a beverage container in the beverage holder 402a. Since the items are properly organized (via the utility item holders 402) in the second position, the user 102 may not be required to locate such items inside the bin 108 while cooking food. When the items are not required, the user 102 may simply rotate the utility item holders 402 to move back to the first position, and close the lid 110.

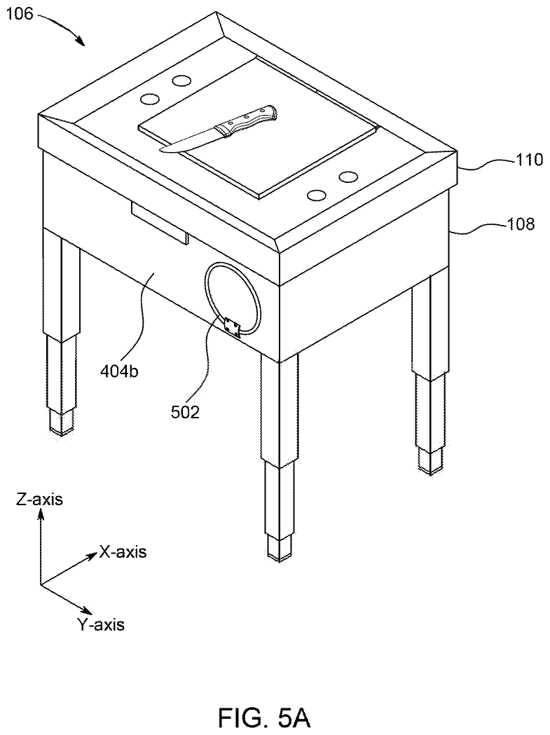

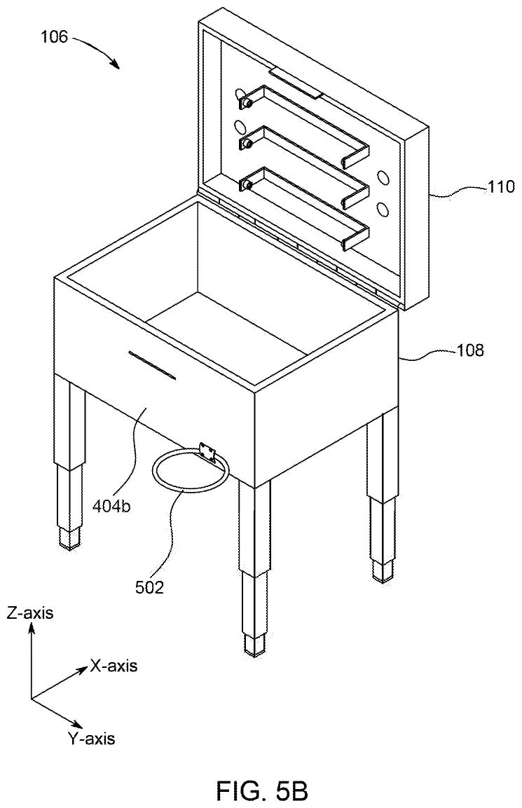

FIGS. 5A and 5B depict an example garbage holder 502 of the system 106 in a closed position and an open position, in accordance with the present disclosure. In some aspects, the system 106 may include the garbage holder 502 that may be connected to a system's outer surface (e.g., to an exterior surface of any of the sidewalls 404). Specifically, the garbage holder 502 may be pivotally connected to a sidewall's outer or exterior surface. Here, pivotal connection means that the garbage holder 502 is configured to rotate about its connection point at the sidewall's exterior surface. In an exemplary aspect, the garbage holder 502 may be shaped as a circular ring (i.e., have a ring like structure) on which the user 102 may removably attach a trash bag to put/hold trash. In some aspects, the garbage holder 502 may be permanently attached to the sidewall 404 (e.g., sidewall 404b). In other aspects, the garbage holder 502 may be removably attached to the sidewall 404. The garbage holder 502 may be made of any material including, but not limited to, plastic, steel, and/or the like. The garbage holder 502 may be of any dimensions. In some aspect, the diameter of the garbage holder 502 may be 10-60% of a sidewall length.

The garbage holder 502 may be configured to move between the open position and the closed position. Specifically, the garbage holder 502 may pivotally rotate between the open position and the closed position. In the closed position, a garbage holder plane may be parallel to a bin longitudinal axis (or a sidewall plane), as shown in FIG. 5A. For example, as shown in FIG. 5A, the garbage holder plane and the sidewall plane are both aligned to the Y-Z plane when the garbage holder 502 is in the closed position. In the open position, the garbage holder plane may be perpendicular to bin longitudinal axis or the sidewall plane, as shown in FIG. 5B. For example, as shown in FIG. 5B, the garbage holder plane is in the X-Y plane and the sidewall plane is in the Y-Z plane when the garbage holder 502 is in the open position.

In some aspects, the garbage holder 502 may automatically move between the closed position and the open position based on a lid position. For example, the garbage holder 502 may automatically move in the closed position when the lid 110 is in the closed position. Similarly, the garbage holder 502 may move to the open position when the lid 110 is in the open position. Stated another way, the movement of the lid 110 may automatically move the garbage holder 502 between the closed and the open positions. In this case, the system 106 may include an automated actuation mechanism that may connect the lid 110 and the garbage holder 502, and may synchronize their movements as described above. In other aspects, the user 102 may manually move the garbage holder 502 between the open position and the closed position.

When the garbage holder 502 may be in the open position, the user 102 may attach the trash bag and put trash in it.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A box system comprising:
a hollow bin having:
a base, and
a plurality of bin sidewalls attached to the base;
a lid configured to cover the hollow bin; and
a utility item holder that is pivotally attached to a bin sidewall of the plurality of bin sidewalls, wherein:
the utility item holder is configured to store one or more items in an upright position,
the utility item holder is configured to rotate and pivotally move between a first position and a second position such that the utility item holder maintains the upright position in the first position and the second position, and
the first position is located in proximity to a bin sidewall inner surface and the second position is located in proximity to a bin sidewall outer surface.

2. The box system of claim 1, wherein the lid comprises a lid top surface and a lid bottom surface, wherein the lid top surface comprises a cutting board.

3. The box system of claim 2, wherein the cutting board is removably attached to the lid top surface.

4. The box system of claim 2, wherein the lid comprises a bracket removably attached to the lid bottom surface, and wherein the bracket is configured to hold rolled goods.

5. The box system of claim 3, wherein the lid bottom surface comprises one or more magnets configured to magnetically attach to ferrous utility items.

6. The box system of claim 2, wherein the lid comprises a gasket at the lid bottom surface.

7. The box system of claim 1, wherein the lid is hinged to a bin top portion.

8. The box system of claim 1, wherein the utility item holder comprises a hook tray.

9. The box system of claim 1, wherein the utility item holder comprises a beverage holder.

10. The box system of claim 1, wherein the utility item holder comprises a storage basket.

11. The box system of claim 1 further comprising a garbage holder pivotally attached to the bin sidewall outer surface.

12. The box system of claim 11, wherein the garbage holder is shaped as a circular ring.

13. The box system of claim 11, wherein the garbage holder is configured to pivotally rotate between a closed position and an open position.

14. The box system of claim 13, wherein the garbage holder is in the closed position when a garbage holder plane is parallel to a bin sidewall plane, and wherein the garbage holder is in the open position when the garbage holder plane is perpendicular to the bin sidewall plane.

15. The box system of claim 1, wherein the base is attached to telescopic legs.

16. The box system of claim 1, wherein the first position is located in a bin interior portion and the second position is located in a bin exterior portion.

17. The box system of claim 16, wherein the bin sidewall inner surface faces the bin interior portion, and the bin sidewall inner surface is opposite to the bin sidewall outer surface.

18. A box system comprising:
a hollow bin having:
a base, and
a plurality of bin sidewalls attached to the base,
a lid configured to cover the hollow bin, wherein the lid comprises a lid top surface and a lid bottom surface, wherein the lid top surface comprises a magnet; and
a utility item holder that is pivotally attached to a bin sidewall of the plurality of bin sidewalls, wherein:
the utility item holder is configured to store one or more items in an upright position,
the utility item holder is configured to rotate and pivotally move between a first position and a second position such that the utility item holder maintains the upright position in the first position and the second position, and
the first position is located in proximity to a bin sidewall inner surface and the second position is located in proximity to a bin sidewall outer surface.

19. The box system of claim 18, wherein the lid top surface comprises a cutting board, and wherein the cutting board is removably attached to the lid top surface.

20. A box system comprising:
a hollow bin having:
a base, and
a plurality of bin sidewalls attached to the base,
a lid configured to cover the hollow bin, wherein the lid comprises a lid top surface and a lid bottom surface, wherein the lid comprises a bracket removably attached to the lid bottom surface, and wherein the bracket is configured to hold rolled goods; and
a utility item holder that is pivotally attached to a bin sidewall of the plurality of bin sidewalls, wherein:
the utility item holder is configured to store one or more items in an upright position,
the utility item holder is configured to rotate and pivotally move between a first position and a second position such that the utility item holder maintains the upright position in the first position and the second position, and
the first position is located in proximity to a bin sidewall inner surface and the second position is located in proximity to a bin sidewall outer surface.
